(19) United States
(12) Patent Application Publication
(10) Pub. No.: US 2004/0064487 A1
(43) Pub. Date: Apr. 1, 2004

(54) Method and apparatus to migrate a database

(76) Inventors: Liem M. Nguyen, Roseville, CA (US); Thomas Vachuska, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/260,500

(22) Filed: Oct. 1, 2002

(51) Int. Cl. G06F 17/30

(52) U.S. Cl. 707/204

(57) ABSTRACT

A method and apparatus is described to migrate database. Data transformations are specified in a configuration file. The configuration file contains both control information and data transformation information. The migration is performed automatically using the configuration file using an object-oriented migration application. A new database is created using the control information in the configuration file. The new database is populated with the appropriate data based on the data transformation information in the configuration file, resulting in a properly updated database.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Virtually all computer applications have at least one associated database for storing application-dependent data. In some cases the data is stored within the application itself. In other cases the data is stored in flat files. In other applications, data is stored in relational databases accessed using structured query language (SQL). Some large applications use data stored in more than one type of database.

As computer applications evolve, the type and quantity of data necessary for the application also evolves. A common method used to assist the application programmer in database design is to develop a database schema. A database schema describes the data by type, size and relationship to other data. Some database environments enable the database designer to create a schema graphically. Others require textual definitions. Data Definition Language (DDL), also called Schema Definition Language in notation of the American National Standards Institute (ANSI), consists of commands that determine which values are present in the database tables at any given time. Typically, as an application evolves, the DDL or schema of the associated database will change.

Current methods for migrating data from the old database to the new and improved database are typically manual. Migration, of course, should ensure that all data is preserved. Methods in the prior art, however, simply toss out data that doesn't map into the new schema. A database modification tool built into SQL, i.e., ALTER_TABLE, only allows altering of the data type, i.e., var, short int, long int, float, etc., but not the data itself.

### SUMMARY

A method and apparatus is described to migrate a database. An embodiment of the method and system is generic enough to transform any SQL database. Data transformations are specified in a configuration file for easy change. The configuration file contains both control information and data transformation information. The migration is performed automatically using the configuration file using an object-oriented migration application. The current database needing transformation is not altered. A new database is created using the control information in the configuration file. The new database is populated with the appropriate data based on the data transformation information in the configuration file, resulting in a properly updated database.

### DESCRIPTION OF THE DRAWINGS

The detailed description will refer to the following drawings, wherein like numerals refer to like elements, and wherein:

FIG. 1 shows a format for an exemplary configuration file used for migrating a SQL database;

FIG. 2 shows an excerpt from an exemplary configuration file, as defined in FIG. 1;

FIG. 3 is a flow diagram showing an exemplary method for migrating a SQL database;

FIG. 4 is class diagram for an object oriented Database Migrator, according to one embodiment;

FIGS. 5A, 5B, 5C and 5D are more detailed views of the classes in the database Migrator embodiment as shown in FIG. 4;

FIG. 6 shows a flow diagram for an exemplary DBTransformer;

FIG. 7 shows a flow diagram of an exemplary validate method;

FIG. 8 shows an exemplary format for a properties file; and

FIG. 9 shoes an exemplary screen shot of a database migration wizard user interface.

### DETAILED DESCRIPTION

The database migrator as described herein provides power and flexibility for modifying both the data and data types during a database migration. All of the data in the original, or current, database is preserved during migration, even if the schema of the new database is drastically changed in a later release. The database migrator is generic enough to work on any SQL database.

All database transformations are described in a configuration file for easy change. One embodiment of the migrator uses a JAVA™ front end to examine the current and new database and compare differences. A skeleton configuration file is automatically generated. The skeleton file is then edited to describe that differences in data between the current schema and the new schema. Data types, table names and column names are automatically generated by the JAVA™ front end.

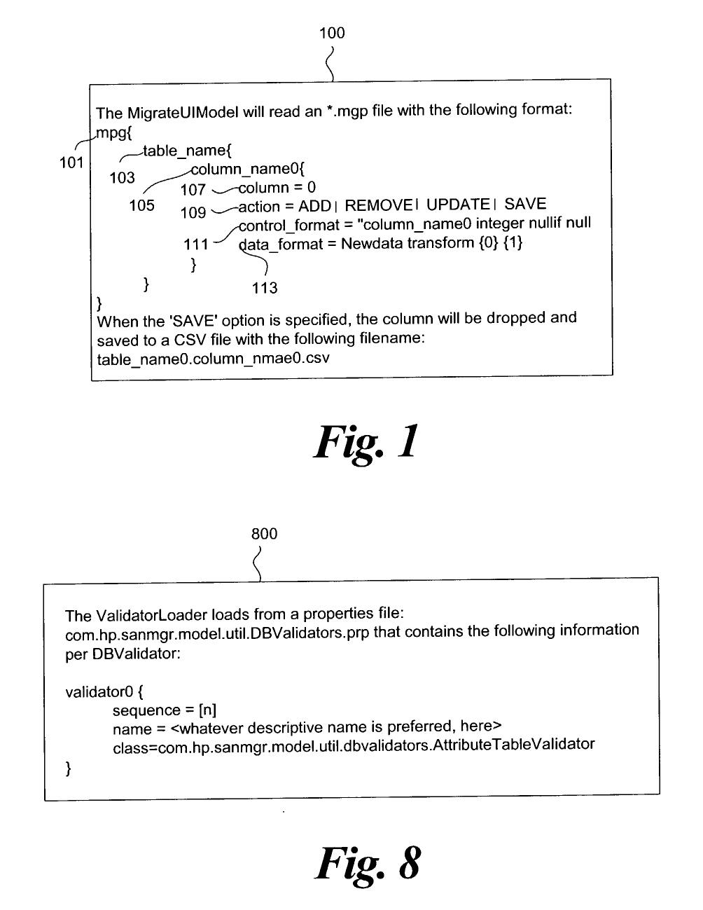

Referring now to the drawings, and in particular to FIG. 1, there is shown an exemplary format 100 for the configuration file describing the migration from the old schema to the new schema. In an exemplary embodiment, the migration configuration file is a text file having an extension of “.mgp.” Different hierarchical items are delineated by curly brackets, i.e., “{” and “}”. The text begins with the mgp keyword 101 to indicate the start of the migration definition. Within a database are tables, and within tables are columns having data of a certain type and use. In the exemplary mgp file there is one table 103, table_name0 having one column 105, column_name0. The column 105 has a location 107 indicated by the column field. In this case the location is 0, or the first column of the table.

An action 109 is identified based on what should be done with the column 105. Four actions are possible: (1) add, (2) remove, (3) update and (4) save. If a column in the new schema is new, and did not exist in the current schema, then the add action is indicated. Similarly, if a column no longer exists, then the remove action is indicated. If the data in the removed table is desirous to save, then the save action is indicated. The save action acts like remove, but saves the table-column data before deleting the column from the database. The data is saved into a comma separated variable file (.csv file). If the column in the new schema has changed, either by type, or length or in another way, then the update action is indicated.

The control_format field 111 indicates what the data type for the column should be in the new database schema. The column, action and control_format 111 fields, e.g., control information, can be derived automatically using the JAVA™ front end. The data_format field 113 indicates how the column data should be changed, or formatted, e.g., data transformation information. In this example, the data in column {0} is to be transformed. The new data consists of data from the old table_name0 columns {0} and {1} which are concatenated together.

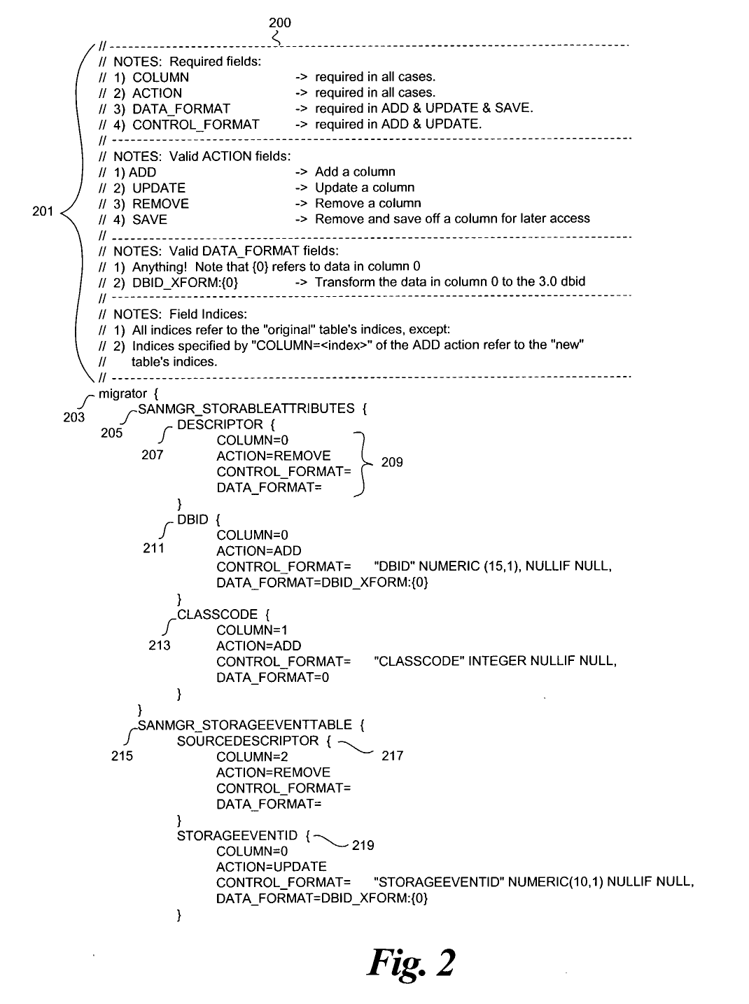

FIG. 2 shows an excerpt from an exemplary .mgp configuration file 200. The first section 201 has comments describing the format of the file. The keyword migrator 203 begins the configuration portion of the file. The first table in the exemplary database to be transformed is SANMGR_STORABLEATTRIBUTES 205. This table has three column actions for DESCRIPTOR, DBID, and CLASSCODE 207, 211, and 213. The column DESCRIPTOR 207 was the first column and is to be removed from the newly transformed table, as shown in the action section 209. In its place, the column DBID 211 is to be added, and its data is taken from the original column {0}. Table CLASSCODE 213 is added as column {1}. A second table SANMGR_STORAGEVENTTABLE 215 is shown as the next table in the configuration file 200. The exemplary configuration file 200 shows that table 215 has two columns requiring transformation: SOURCEDESCRIPTOR 217 and STORAGEVENTID 219. It will be apparent to one of ordinary skill in the art that larger databases will require a large configuration file to describe each table and associated columns.

In one embodiment, a skeleton of the configuration file 200 is generated automatically using a JAVA™ utility. (JAVA™ is a trademark of Sun Microsystems, Inc.) Appendix A shows an exemplary JAVA™ package for automatically generating a configuration file to be used in the transformation of a Solid™ database. (Solid™ is a trademark of Solid Information Technology Corp.) The JAVA™ utility reads both the old schema, for the current database, and the new schema and compares them. Each table and column is compared to determine whether the tables or columns need to be added, removed, or updated. While the exemplary utility is used to compare the schemas for a Solid™ database structure, it will be apparent to one skilled in the art that utilities for other databases can easily be developed. Once the skeleton configuration file 200 is generated, a database designer/developer/administrator edits the file to add in the data specifics. The control specifics are generated by the JAVA™ utility.

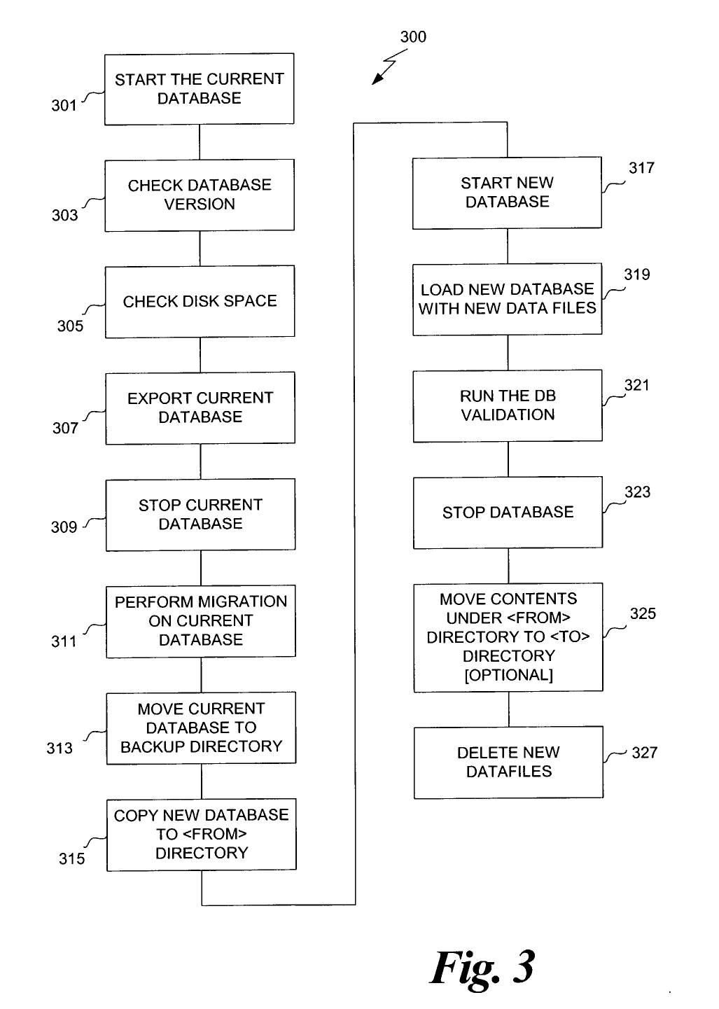

Referring now to FIG. 3, there is shown an exemplary flow diagram 300 for a database migrator, as described herein. Once the configuration file has been generated, an automated migrator, or database transformer, is executed. The migrator can be run using either a command line user interface (CLUI) or graphics user interface (GUI). First, the current database is started in step 301. The database version is checked in step 303. If the version has not changed, then no migration is needed and the process exits. A preferred embodiment checks to ensure that enough temporary space remains in the storage area, typically a hard disk, to run the migration, in step 305.

The current data base is exported in step 307. In one embodiment, the database tables are written to comma separated files (.csv files). The current database is stopped, to maintain data integrity in step 309. The migration continues in step 311 by creating the new database based on the control information in the configuration file. The old database files is moved to a backup directory for safety and configuration management in step 313. The new database is move to the target location in step 315 and started in step 317. The new database is then loaded with the new data files in step 319. In comparison to the current, or now old, database, the new database has new tables added, when necessary; updated old tables, and deleted obsolete tables, based on the action field 109 in the configuration file. The .csv files holding the current database information are not modified during migration. The new database was created using the old data and new control and data information contained in the configuration file.

A database validation process is run in step 321, and then the database is stopped in step 323. Validation is a post-process that is part of the migration process. The ValidatorLoader will load all the validator components specified in a configuration, or properties, file (.prp), instantiate them via JAVA's introspection mechanism, and run them one by one according to the sequence (order) number specified in the same properties file. The validators have the ability to access Clay (an Object-Oriented wrapper around the database), allowing cross-table data manipulation and validation much easier than at the SQL level.

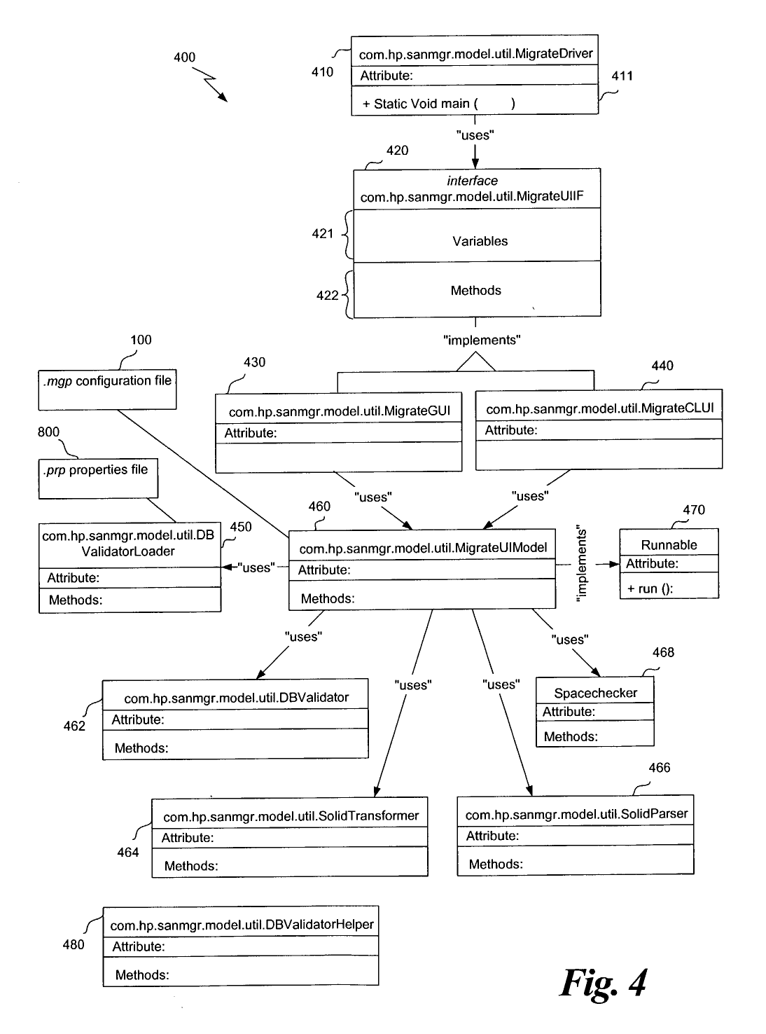

One embodiment of the migrator described herein uses object oriented methods to perform the migration. Referring to FIG. 4, there is a class diagram 400 showing the classes and methods used to perform database migration. The main driver com.hp.sanmgr.model util.MigrateDriver 410 is the driver that controls the migration. The driver 401 has one method, main 411. The driver uses the interface com.hp.sanmgr.model.util.MigrateUIIF 420. This interface class has public static variables 421 and methods 422. The interface then implements either the GUI 430, com.hp.sanmgr.model.util.MigrateGUI or the CLUI com.hp.sanmgr.model.util.MigrateCLUI 440. Regardless of whether the user interface is graphic or command line, the user interface uses the migration model com.hp.sanmgr.model.util.MigrateUIModel 460. The migration model 460 uses a ValidatorLoader class 450, as well as, a Validator class 462, a transformer class for the Solid™ database, SolidTransformer, 464 and a SolidParser class 466. There is a Validator instance of the DBValidator class 462 for each table. The migration model class 460 also implements the runnable class 470, which is just a JAVA™ class that allows any class that implements it to be run as a Thread.

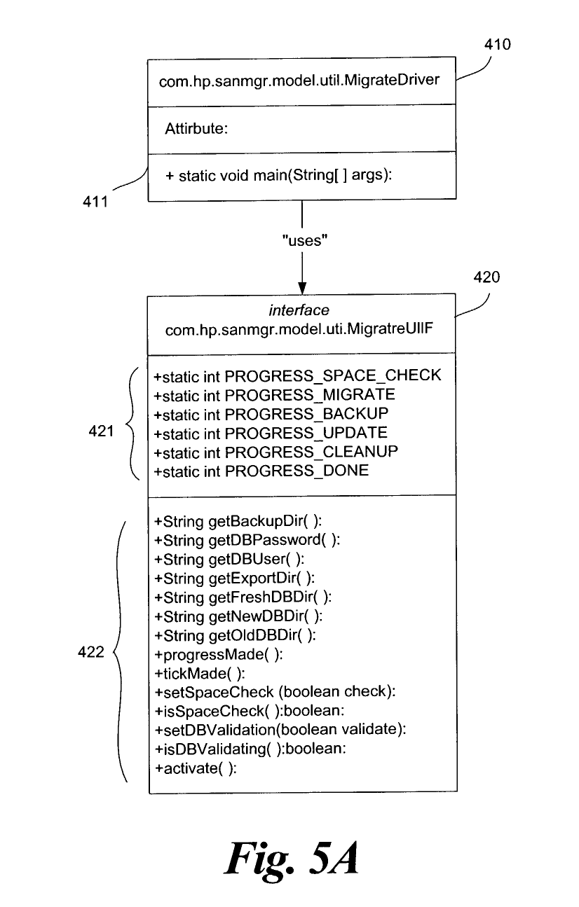

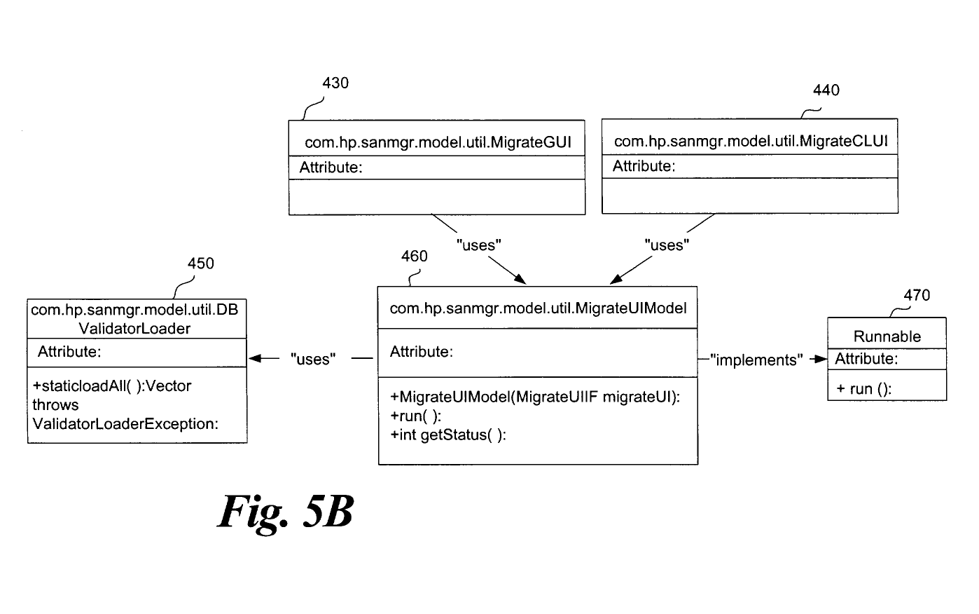

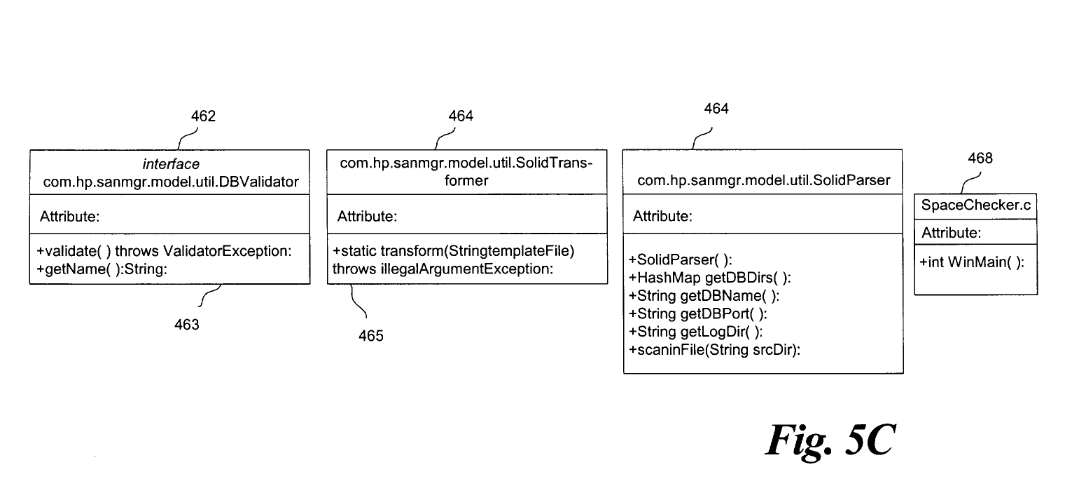

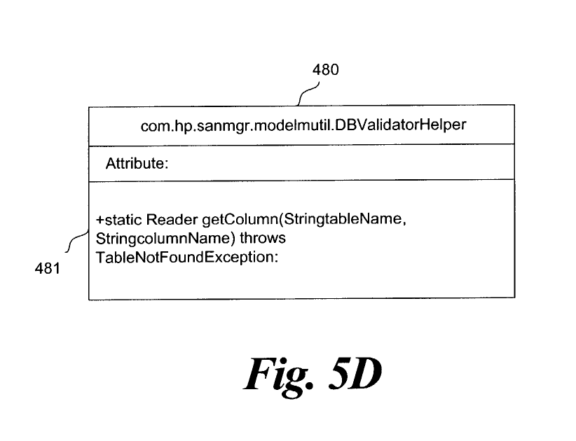

FIG. 5A,shows a more detailed view of the driver class 410 and the interface class 420. FIG. 5B shows a more detailed view of the MigrateGUI 430, MigrateCLUI 440 and associated classes. FIG. 5C shows a more detailed view of the DBValidator 462, SolidTransformer 464, SolidParser 466 and SpaceChecker 468 classes. FIG. 5D shows a more detailed view of the DBValidatorHelper class 480.

Referring to FIG. 5C, a static method transform 465 of the SolidTransformer class 464 is used to read the configuration file and perform the database transformation. The exemplary embodiment uses a transformation for a Solid™ database, but it will be apparent to one of ordinary skill in the art how this transformers is to be adapted to transform other databases.

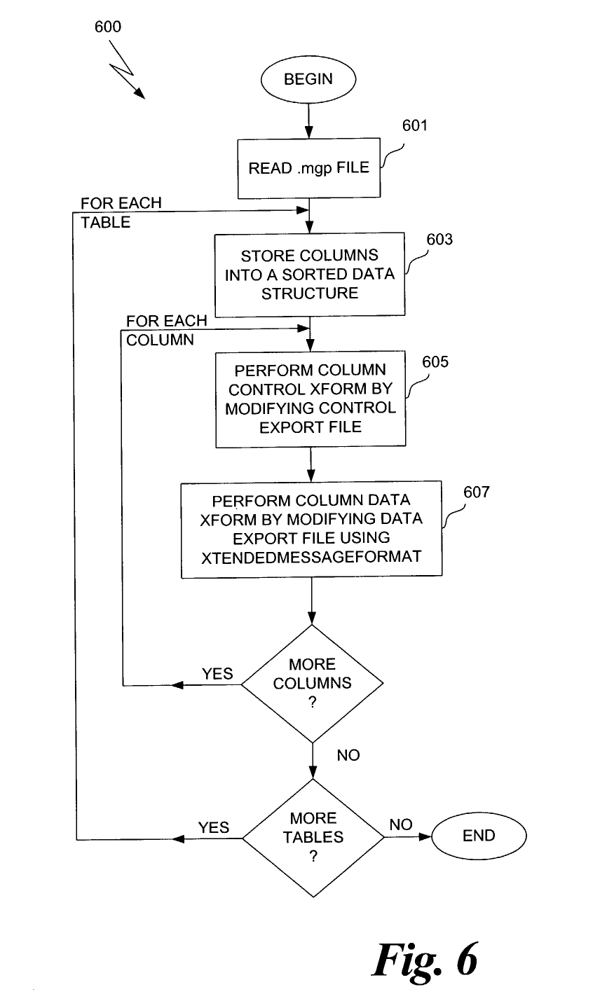

Referring now to FIG. 6, there is shown a flow diagram 600 for an exemplary DBTransformer. The .mgp file is read in step 601. For each table, the columns to be transformed are stored into a sorted data structure, in step 603. Each element in this data structure represents a column to be transformed and will know exactly what action to perform, e.g., ADD, UPDATE, REMOVE, or SAVE, and how to transform both the control format and the data format. For each column, the control transformation is performed by modifying the control export file according to the data structure element that represents that column, in step 605.

For each column, the data transformation is performed by modifying the data export file according to the data structure element that represents that column, in step 607. The data transformation also utilizes a powerful XtendedMessageFormat class similar to the JAVA™ MessageFormat to allow flexible concatenation of different fields of a record. Custom expandable transformation schemes such as “UNIQUE” and “DBID-XFORM” allow the data transformation to understand “custom” transformation schemes specified in the .mgp file.

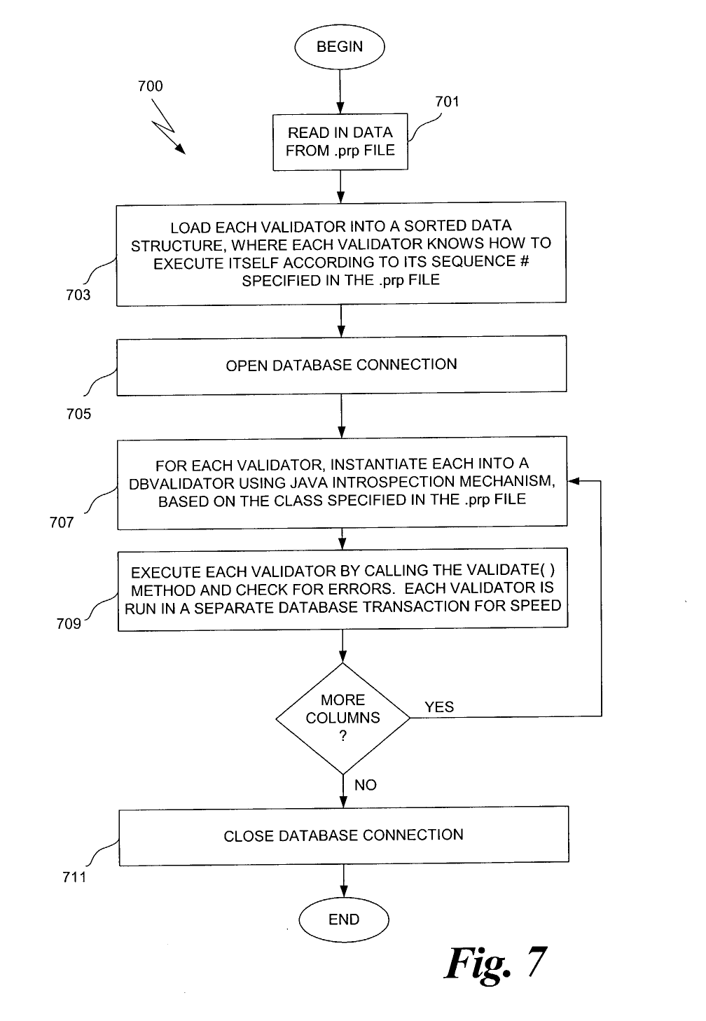

Referring again to FIG. 5C, the DBValidator uses a method validate 463. An exemplary method for validation 700 is shown in FIG. 7. Referring now to FIG. 7, validation begins with reading a properties file (.prp file) in step 701. FIG. 8 shows a format for the properties file 800. There is a validator for each table that requires validation. The data validators are completely independent and they can be designed to do almost anything. For instance, the validators can move data from one table to another table, or combine column data. For each validator, the properties file defines its name and in what sequence it should be loaded. One of the more useful functions of the validator is the ability to access Clay and do cross-table manipulation programmatically vs. via SQL. Other things validators can do are: 1) make sure that the data in the new columns that have been added to an existing table is valid (validity is defined in the sense of the product) and 2) make sure that if the data is changed in one table, all the other tables that reference that data are changed, if required.

Each validator is loaded into a sorted data structure in step 703, where each validator knows how to execute itself according to its sequence specified in the properties file. A database connection is opened in step 705. For each validator, a DBValidator instance is created in step 707. The exemplary embodiment uses the JAVA™ introspection mechanism to instantiate the DBValidators, based on the class specified in the properties file. Each validator instance is executed by calling the validate( ) method in step 709. Error checking is also performed. It is preferred to run each validator in a separate database transaction for speed purposes. Once validation is complete, the database connection is closed in step 711.

Referring again to FIG. 5C, the SolidParser class 464 uses several methods to parse the database. This class is used to retrieve database specific information, including database name, database port, transaction lock file, locations of all database files, locations of all transaction logs, etc. The SpaceChecker class 468 determines whether sufficient storage space is available to perform the transformation. If there is not sufficient storage, the process terminates.

Referring again to FIG. 5D, there is shown the DBValidatorHelper class 480. This is a miscellaneous class to help out with the validation. Basically, if the validator wants access to a flat file, it will use this method getColumn 481. The validator does not need to know where the files are located. Everything is accessed through convenient methods in this DBValidatorHelper. The validator helper has other convenient methods, such as getting certain data transformation done, e.g., transforming a primary key of the old schema to the “new” primary key of the new schema. The purpose of this class is to facilitate the work of the validators. It will be apparent to one of ordinary skill in the art how to develop new methods to suit the needs of the validators.

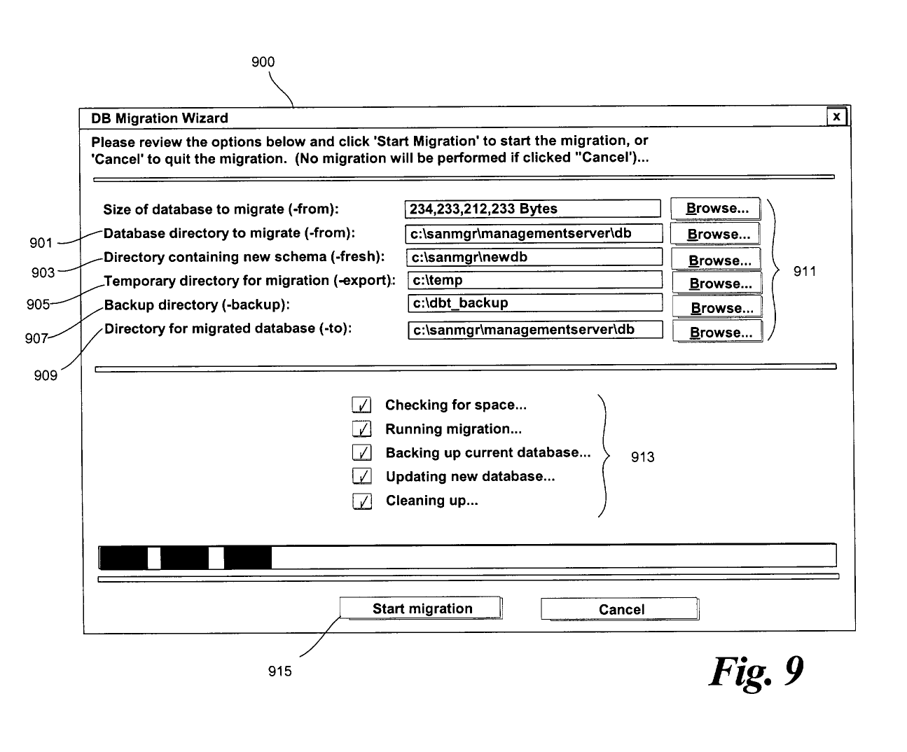

In another embodiment, the graphic user interface represented by the com.hp.sanmgr.model.util.MigrateGUI class 430 is a “wizard”, named DBMigration Wizard. FIG. 9 shows an exemplary user interface wizard that is used to execute the migrator. The database administrator/designer enters database directory to migrate from 901; directory containing the new schema 903; a temporary directory for migration 905; a backup directory 907; and a directory for the migrated database 909. A “browse” button 911 may be used to search for the appropriate directories. Once the Migration has begun, by selecting the “Start Migration” button 915, a progress status is displayed 913.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

APPENDIX A. JAVA Utility For Creating A Configuration File

| | |
|---|---|
| 1 | Copyright 2002. Hewlett-Packard Company. All Rights Reserved. |
| 2 | |
| 3 | import java.io.*; |
| 4 | import java.util.*; |
| 5 | |
| 6 | /** |
| 7 | * Class to generate the mgp file, given the exported |
| 8 | * old and new db directories. |
| 9 | * |
| 10 | * @author Liem Nguyen |
| 11 | */ |
| 12 | public class SolidMGPSync { |

| 13 | private static final String SPACER = “ ”; | |
|---|---|---|
| 14 | private PrintWriter writer; | |
| 15 | | |
| 16 | public SolidMGPSync | (String oldSchemaDir, |

| | |
|---|---|
| 17 | String newSchemaDir, |
| 18 | string mgpFile) { |

| | |
|---|---|
| 19 | File oldSchema = new File (oldSchemaDir); |
| 20 | File newSchema = new File (newSchemaDir); |
| 21 | try { |

| | |
|---|---|
| 22 | writer = new PrintWriter ( |

| | |
|---|---|
| 23 | new FileOutputStream (mgpFile, true), true); |

| | |
|---|---|
| 24 | } catch (FileNotFoundException e) { |

| | |
|---|---|
| 25 | throw new IllegalArgumentException (“No mgp file found!”); |

| | |
|---|---|
| 26 | } |
| 27 | |
| 28 | // List all the control files . . . |
| 29 | FileFilter ctrFilter = new CtrFilter (); |
| 30 | File [] oldFiles = oldSchema.listFiles (ctrFilter); |
| 31 | File [] newFiles = newSchema.listFiles (ctrFilter); |
| 32 | |
| 33 | // Sanity check . . . |
| 34 | if ( (oldFiles.length == 0) \|\| (newFiles.length == 0)) { |

| | |
|---|---|
| 35 | throw new IllegalArgumentException (“No control files |

| | |
|---|---|
| 36 | found!”); |

| | |
|---|---|
| 37 | } |
| 38 | |
| 39 | // Write opening file . . . |
| 40 | writer.println (“migrator {”); |
| 41 | |
| 42 | // Let's compare control files, one by one . . . |
| 43 | for (int i=0; i<oldFiles.length; i++) { |

| | |
|---|---|
| 44 | File newFile = new File (newSchemaDir + |

| | |
|---|---|
| 45 | File.separator + |
| 46 | oldFiles [i] .getName ()); |

| | |
|---|---|
| 47 | if (newFile.exists () ) { |

| | |
|---|---|
| 48 | try { |

| | |
|---|---|
| 49 | fileCompare (oldFiles [i], newFile); |

| | |
|---|---|
| 50 | } catch (Throwable t) { |

| | |
|---|---|
| 51 | t.printStackTrace (); |

| | |
|---|---|
| 52 | } |

| | |
|---|---|
| 53 | } |

| | |
|---|---|
| 54 | } |
| 55 | |
| 56 | // Close opening file . . . |
| 57 | writer.println (“}”); |
| 58 | writer.close (); |

| | |
|---|---|
| 59 | } |
| 60 | |
| 61 | private void fileCompare (File oldFile, |

| | |
|---|---|
| 1 | File newFile) throws Throwable { |

| | |
|---|---|
| 2 | List oldKeys = new ArrayList (); |
| 3 | List aidValues = new ArrayList (); |
| 4 | List newKeys = new ArrayList (); |
| 5 | List newValues = new ArrayList (); |
| 6 | |
| 7 | parseCtr (oldFile, oldKeys, olaidValues, true); |
| 8 | parseCtr (newFile, newKeys, newValues, false); |
| 9 | |
| 10 | String tableName = oldFile.getName (); |
| 11 | tableName = tableName.substring (0, |

| | |
|---|---|
| 12 | tableName. lastIndexOf (“.ctr”)); |

| | |
|---|---|
| 13 | updateMgp (tableName, oldKeys, oldValues, newKeys, newValues); |

| | |
|---|---|
| 14 | } |
| 15 | |
| 16 | /** |
| 17 | * Output: lists of keys and values from the given control file. |
| 18 | */ |
| 19 | private void parseCtr (File ctrFile, |

| | |
|---|---|
| 20 | List keys, |
| 21 | List values, |
| 22 | boolean stripEndcomma) throws Throwable { |

| | |
|---|---|
| 23 | BufferedReader file = new BufferedReader (new |

| | |
|---|---|
| 24 | FileReader (ctrFile)); |

| | |
|---|---|
| 25 | String s; |
| 26 | |
| 27 | // skip comments section of control file . . . |
| 28 | while (! (s = file.readLine ()) .equals (“(”)) { } |
| 29 | |
| 30 | // read in the column values . . . |
| 31 | while (! (s = file.readLine () .trim ()) .equals (“)”)) { |

| | |
|---|---|
| 32 | keys.add (getKey (s)); |
| 33 | if (stripEndComma) { |

| | |
|---|---|
| 34 | values.add (stripComma (s)); |

| | |
|---|---|
| 35 | } else { |

| | |
|---|---|
| 36 | values.add (s); |

| | |
|---|---|
| 37 | } |

| | |
|---|---|
| 38 | } |

| 39 | } | |
|---|---|---|
| 40 | | |
| 41 | /** | |
| 42 | * 1) | old key is NOT in new key −> REMOVE |
| 43 | * 2) | new value is in old value −> do nothing. |
| 44 | * 3) | new value is NOT in old value: |
| 45 | * | a) if new key is in old key −> UPDATE |
| 46 | * | b) if new key is NOT in old key −> ADD |
| 47 | */ | |

| | |
|---|---|
| 48 | private void updateMgp (String tableName, |

| | |
|---|---|
| 49 | List oldKeys, |
| 50 | List oldValues, |
| 51 | List newKeys, |
| 52 | List newValues) { |

| | |
|---|---|
| 53 | boolean headerprinted = false; |
| 54 | |
| 55 | // case1: |
| 56 | int listSize oldKeys.size (); |
| 57 | for (int i=0; i<listSize; i++) { |

| | |
|---|---|
| 58 | if (!newKeys.contains (oldKeys.get (i))) { |

| | |
|---|---|
| 59 | headerPrinted = printHeader (tableName, headerprinted); |
| 60 | print (i, “REMOVE”, (String) oldKeys.get (i), “”); |

| | |
|---|---|
| 61 | } |

| | |
|---|---|
| 1 | } |
| 2 | |
| 3 | // case 3: |
| 4 | listSize = newvalues.size (); |
| 5 | for (int i=0; i<listSize; i++) { |

| | |
|---|---|
| 6 | if |

| | |
|---|---|
| 7 | (!oldValues.contains (stripComma ((String) newValues.get (i)))) { |

| | |
|---|---|
| 8 | headerPrinted = printHeader (tableName, headerPrinted); |
| 9 | |
| 10 | if (oldKeys.contains (newKeys.get (i))) { |

| | |
|---|---|
| 11 | // case 3a: |
| 12 | print (oldKeys.indexOf (newKeys.get (i)), |

| | |
|---|---|
| 13 | “UPDATE”, (String) newKeys.get (i), |

| | |
|---|---|
| 14 | (String)newValues.get (i)); |

| | |
|---|---|
| 15 | } else { |

| | |
|---|---|
| 16 | // case 3b: |
| 17 | print (i, “ADD”, (String) newKeys.get (i) |

| | |
|---|---|
| 18 | (String) newValues.get (i)) |

| | |
|---|---|
| 19 | } |

| | |
|---|---|
| 20 | } |

| | |
|---|---|
| 21 | } |
| 22 | printFooter (headerPrinted); |

| | |
|---|---|
| 23 | } |
| 24 | |
| 25 | /** |
| 26 | * Print the footer |
| 27 | */ |
| 28 | private void printFooter (boolean headerprinted) { |

| | |
|---|---|
| 29 | if (headerPrinted) { |

| | |
|---|---|
| 30 | writer.println (SPACER + “}”); |

| | |
|---|---|
| 31 | } |

| | |
|---|---|
| 32 | } |
| 33 | |
| 34 | /** |
| 35 | * Print the header |
| 36 | */ |
| 37 | private boolean printHeader (String tableName, |

| | |
|---|---|
| 38 | boolean headerprinted) { |

| | |
|---|---|
| 39 | if (!headerPrinted) { |

| | |
|---|---|
| 40 | writer.println (SPACER + tableName + “ {”); |
| 41 | headerPrinted = true; |

| | |
|---|---|
| 42 | } |
| 43 | return headerPrinted; |

| | |
|---|---|
| 44 | } |
| 45 | |
| 46 | /** |
| 47 | * Print the table that changed. |
| 48 | */ |
| 49 | private void print (int column, |

| | |
|---|---|
| 50 | String action, |
| 51 | String key, |
| 52 | String value) { |

| | |
|---|---|
| 53 | writer.println (SPACER + SPACER + key + “ {”); |
| 54 | writer.println (SPACER + SPACER + SPACER + “COLUMN=” + column); |
| 55 | writer.println (SPACER + SPACER + SPACER + “ACTION=” + action); |
| 56 | writer.println (SPACER + SPACER + SPACER + “CONTROL_FORMAT=\t” + |

| | |
|---|---|
| 57 | value); |

| | |
|---|---|
| 58 | writer.println (SPACER + SPACER + SPACER + “DATA_FORMAT=”); |
| 59 | writer.println (SPACER + SPACER + “}”); |

| | |
|---|---|
| 60 | } |
| 61 | |
| 1 | /** |
| 2 | * Get the column key, with no ‘″’. |
| 3 | */ |
| 4 | private String getKey (String s) { |

| | |
|---|---|
| 5 | return s.substring (s.indexOf (‘″’) +1, s.lastIndexOf (‘″’)); |

| | |
|---|---|
| 6 | } |
| 7 | |
| 8 | /** |
| 9 | * Get the column value, with no ‘,’. |
| 10 | */ |
| 11 | private String stripComma (String s) { |

| | |
|---|---|
| 12 | return (s.endsWith (“,”)) ? s.substring (0, s.length () −1) : s; |

| | |
|---|---|
| 13 | } |
| 14 | |
| 15 | private class CtrFilter implements FileFilter { |

| | |
|---|---|
| 16 | public boolean accept (File pathname) { |

| | |
|---|---|
| 17 | return pathname.getName () .endsWith (“.ctr”); |

| | |
|---|---|
| 18 | } |

| | |
|---|---|
| 19 | } |
| 20 | |
| 21 | /** TEST HARNESS */ |
| 22 | public static void main (String[] argv) { |

| | |
|---|---|
| 23 | if (argv.length < 3) { |

| | |
|---|---|
| 24 | system.err.println (“Usage: java SolidMGPSync ”+ |

| | |
|---|---|
| 25 | “<oldschemadir> <newschemadir> |

| | |
|---|---|
| 26 | <mgpfile>”); |

| | |
|---|---|
| 27 | System.exit (1); |

| | |
|---|---|
| 28 | } |
| 29 | new SolidMGPSync (argv [0], argv [1], argv [2]); |

| | |
|---|---|
| 30 | } |

| | |
|---|---|
| 31 | } |

32

In the claims:

1. A method for migrating a current database to an updated database, comprising:
starting a current database for migrating to an updated database;
reading a configuration file having both data transformation information and control information defining modifications to be made to the current database to effect a migration to the updated database;
exporting data from the current database;
creating the updated database based on control information in a configuration file;
moving the updated database to a target location; and
loading the updated database with new data files based on data transformation information in the configuration file.

2. The method as recited in claim 1, further comprising:
determining a version of the current database, and if the version is a same version as the updated database, then exiting before exporting data from the current database.

3. The method as recited in claim 1, wherein exporting data from the current data base further comprises stopping the current database.

4. The method as recited in claim 1, wherein loading the updated current data base further comprises starting the updated database.

5. The method as recited in claim 1, further comprising:
determining whether adequate storage space exists to migrate the current database, and if not, then exiting before exporting data from the current database.

6. The method as recited in claim 1, wherein the exporting generates comma separated files.

7. The method as recited in claim 1, further comprising:
moving the exported database files to a backup directory.

8. The method as recited in claim 1, further comprising:
automatically validating tables in the updated database based on database validation procedures.

9. The method as recited in claim 1, wherein the configuration file further comprises a plurality of actions corresponding to table and column information.

10. The method as recited in claim 9, wherein the plurality of actions are selected from a group consisting of add, remove, delete and update.

11. The method as recited in claim 1, further comprising:
automatically generating a skeleton configuration file having control information; and
editing the skeleton configuration file with data transformation information, resulting in the configuration file having both data transformation information and control information.

12. The method as recited in claim 11, wherein the configuration file is generated using a JAVA™ utility, and wherein the JAVA™ utility examines a schema for the current database and a schema and the updated database to determine differences in control information.

13. The method as recited in claim 12, wherein the control information comprises data types, table names, and column names.

14. A database migrator for transforming a current database into an updated database, comprising:
a module comprising a user interface running on a computing device capable of executing object-oriented computer programs;
a first section of object oriented computer code defining a migration model used by the user interface, the migration model using a configuration file having control information and data transformation information, wherein the configuration file defines changes required to transform a current database into an updated database;
a second section of object-oriented computer code defining a database transformer class; and
a third section of object-oriented computer code defining a database parser class.

15. The migrator as recited in claim 14, further comprising a fourth section of object-oriented computer code defining a database validator class.

16. The migrator as recited in claim 14, wherein the user interface is selected from a group of a graphic user interface (GUI) and a command line interface (CLUI).

17. The migrator as recited in claim 14, further comprising a further section of object-oriented computer code defining a database validator loader, wherein the validator loader reads a properties file and loads a plurality of validator instances, each validator instance corresponding to a database table.

18. The migrator as recited in claim 14, wherein the user interface allows a user to specify: a database directory to migrate from; a directory containing a new schema; a temporary directory for migration; a backup directory; and a directory in which to place a migrated database.

19. The migrator as recited in claim 14, wherein a transformer method of the database transformer class is used to read the configuration file and perform database transformation.

20. The migrator as recited in claim 19, wherein for each table, columns to be transformed are stored into a sorted data structure, wherein each element in the sorted data structure represents a column to be transformed and has a corresponding action, and wherein for each column, control transformation is performed by modifying a control export file according to the data structure element that represents that column, and wherein for each column, the data transformation is performed by modifying the data export file according to the data structure element that represents that column.

21. The migrator as recited in claim 20, wherein data transformation utilizes a XtendedMessageFormat class to allow flexible concatenation of different fields of a record.

22. The migrator as recited in claim 14, further comprising automated means for generating a skeleton configuration file comprising data control information.

23. The migrator as recited in claim 22, wherein automated means for generating is a JAVA™ utility, the JAVA™ utility comparing a first schema corresponding to the current database and a second schema corresponding to the updated database.

24. A computer readable medium containing code sections for transforming a current database into an updated database, said medium comprising:
a first code section for implementing a user interface running on a computing device capable of executing object-oriented computer programs;
a second section of object oriented computer code defining a migration model used by the user interface, the migration model using a configuration file having control information and data transformation information, wherein the configuration file defines changes required to transform a current database into an updated database;
a third section of object-oriented computer code defining a database transformer class; and
a fourth section of object-oriented computer code defining a database parser class.

25. The computer readable medium as recited in claim 24, further comprising a fifth section of object-oriented computer code defining a database validator class.

26. The computer readable medium as recited in claim 24, wherein the user interface is selected from a group of a graphic user interface (GUI) and a command line interface (CLUI).

27. The computer readable medium as recited in claim 24, further comprising a further section of object-oriented computer code defining a database validator loader, wherein the validator loader reads a properties file and loads a plurality of validator instances, each validator instance corresponding to a database table.

28. The computer readable medium as recited in claim 24, wherein the user interface allows a user to specify; a database directory to migrate from; a directory containing a new schema; a temporary directory for migration; a backup directory; and a directory in which to place a migrated database.

29. The computer readable medium as recited in claim 24, wherein a transformer method of the database transformer class is used to read the configuration file and perform database transformation.

30. The computer readable medium as recited in claim 29, wherein for each table, columns to be transformed are stored into a sorted data structure, wherein each element in the sorted data structure represents a column to be transformed and has a corresponding action, and wherein for each column, control transformation is performed by modifying a control export file according to the data structure element that represents that column, and wherein for each column, the data transformation is performed by modifying the data export file according to the data structure element that represents that column.
